(19) United States
(12) Patent Application Publication
(10) Pub. No.: US 2023/0044341 A1
(43) Pub. Date: Feb. 9, 2023

(54) ACCESSORY AND ASSEMBLY OF ACCESSORY AND SHELL-SHAPED TOOTH REPOSITIONER

(71) Applicant: WUXI EA BIOTECHNOLOGY LIMITED, Xinwu District Wuxi (CN)

(72) Inventors: Yikan ZHENG, Shanghai (CN); Lei HUANG, Shanghai (CN); Chuncheng ZHANG, Shanghai (CN); Ketuo ZHOU, Shanghai (CN)

(21) Appl. No.: 17/971,055

(22) Filed: Oct. 21, 2022

Related U.S. Application Data
(63) Continuation-in-part of application No. PCT/CN2021/073623, filed on Jan. 25, 2021.

(30) Foreign Application Priority Data
Apr. 22, 2020 (CN) 202020612737.X

(51) Int. Cl. A61C 7/08

(52) U.S. Cl. CPC A61C 7/08

(57) ABSTRACT

Provided is an accessory for being fixed on tooth and enabling a shell-shaped tooth repositioner to apply forces to the tooth, wherein the accessory is a 3D body enclosed by a bottom surface, a guiding surface and N successively-adjoined force-applying surfaces, the accessory can be fixed on the tooth by bonding the bottom surface and a surface of the tooth, the bottom surface and the guiding surface adjoin each of the N successively adjoined force applying surface, transition between the guidance surface and the surface of the tooth is gentler than transition between each of the N force-applying surfaces and the surface of the tooth, N is a natural number greater than or equal to 2, among the N successively-adjoined force-applying surfaces, an angle between a first force-applying surface and the N^{th} force applying surface is greater than or equal to 60° and less than or equal to 120°.

### CROSS REFERENCE TO RELATED APPLICATIONS

This application is Continuation-in-Part of and claims priority to International Application No. PCT/CN2021/073623 filed on Jan. 25, 2021 which claims priority to Chinese Patent Application No. 202020612737.X filed on Apr. 22, 2020, both of which are incorporated by reference herein in their entirety.

### FIELD OF THE APPLICATION

The present application generally relates to accessory and assembly of accessory and shell-shaped tooth repositioner for orthodontic treatment.

### BACKGROUND

Shell-shaped tooth repositioners made of polymer materials become more and more popular due to their advantages on aesthetic appearance, convenience and hygiene. An orthodontic treatment utilizing shell-shaped tooth repositioners usually requires a series of successive shell-shaped tooth repositioners. The geometry of a tooth-receiving cavity of each of these shell-shaped tooth repositioners substantially matches a tooth arrangement to be achieved by a corresponding repositioning step.

In many cases, it is difficult to ensure that a repositioning force system with appropriate magnitudes and directions will be applied on teeth by using a shell-shaped tooth repositioner only. For example, when a tooth is repositioned along proximal or distal direction of a dental arch, although translation of the tooth is expected, a large tipping torque is apt to be generated in actual operations, and this will cause excessive movement of the incisal edge of the tooth along the direction, thereby causing the tooth to undergo undesired tipping. In clinic applications, to avoid the above problem and to apply on the tooth a repositioning force system which is closer to a force system that is needed to achieve a design target, it is usually necessary to additionally fix a protruding accessory having a certain shape on the tooth by a method such as adhesion, and form a corresponding cavity for receiving the accessory on the shell-shaped tooth repositioner. An auxiliary force system is applied on the tooth which is generated by squeezing and friction between the cavity and the accessory, so that the general repositioning force system applied on the tooth is closer to the desired force system.

It can be seen that accessory is crucial for orthodontic treatment using shell-shaped tooth repositioners. The Inventors of the present application discover that conventional accessories are not able to satisfy the following aspects at the same time: (1) convenience of putting on and/or removing the shell-shaped tooth repositioner; (2) easy placement of the shell-shaped tooth repositioner in position; and (3) exertion of sufficient forces. Therefore, it is necessary to provide a new accessory.

### SUMMARY

In one aspect, the present application provides an accessory to be fixed on a tooth which enables a shell-shaped tooth repositioner to apply forces to the tooth through the accessory, the accessory is a 3D body enclosed by a bottom surface, a guiding surface and N successively-adjoined force-applying surfaces, wherein when the accessory is fixed on the tooth, the bottom surface abuts against a surface of the tooth, transition between the guiding surface and the tooth surface is gentler than transition between the successively adjoined force-applying surfaces and the tooth surface, wherein N is a natural number greater than or equal to 2, and wherein among the N successively-adjoined force-applying surfaces, an angle between a first force-applying surface and the N^{th} force applying surface is greater than or equal to 60° and less than or equal to 120°.

In some embodiments, the guiding surface shares one part of the edge of the bottom surface, and the N successively adjoined force applying surfaces share the rest of the edge of the bottom surface. In some embodiment, N may be equal to 2.

In some embodiments, the two adjoined force-applying surfaces may be planes and perpendicular to each other.

In some embodiments, the N successively-adjoined force-applying surfaces may be parallel to a normal direction of the bottom surface.

In some embodiments, a part of the guidance surface, which adjoins the bottom surface, may be a cambered surface or a curved surface.

In another aspect, the present application provides an assembly of an accessory and a shell-shaped tooth repositioner, the accessory is to be fixed on a tooth, the shell-shaped tooth repositioner is to be worn on teeth, on one of which the accessory is fixed, to re-position the teeth from a first tooth arrangement to a second tooth arrangement, the accessory is a 3D body enclosed by a bottom surface, a guiding surface and N successively-adjoined force-applying surfaces, wherein when the accessory is fixed on the tooth, the bottom surface thereof abuts against a surface of the tooth, transition between the guiding surface and the tooth surface is gentler than transition between the N successively-adjoined force-applying surfaces and the tooth surface, wherein the shell-shaped tooth repositioner is a one piece shell which forms a first cavity for receiving the teeth and a second cavity for receiving the accessory, wherein when the shell-shaped tooth repositioner is worn on the teeth on one of which the accessory is fixed, walls of the second cavity abut against and apply forces to at least two of the N successively-adjoined force-applying surfaces of the accessory, wherein N is a natural number greater than or equal to 2, and wherein among the N successively-adjoined force-applying surfaces, an angle between a first force-applying surface and the N^{th} force applying surface is greater than or equal to 60° and less than or equal to 120°.

In some embodiments, the guiding surface shares one part of the edge of the bottom surface, and the N successively adjoined force applying surfaces share the rest of the edge of the bottom surface.

In some embodiments, N may be equal to 2.

In some embodiments, the two adjoined force-applying surfaces of the accessory may be planes and perpendicular to each other.

In some embodiments, the N successively-adjoined force-applying surfaces of the accessory may be parallel to a normal direction of the bottom surface.

In some embodiments, a part of the guiding surface of the accessory which adjoins the bottom surface may be a cambered surface or a curved surface.

### BRIEF DESCRIPTION OF THE DRAWINGS

The above and other features of the present application will be further illustrated below with reference to figures and their detailed description. It should be appreciated that these figures only show several exemplary embodiments according to the present application, so they should not be construed as limiting the protection scope of the present application. Unless otherwise specified, the figures are not necessarily drawn to scale, and similar reference numbers therein denote similar components.

FIG. 1 schematically illustrates an accessory in one embodiment of the present application;

FIG. 2 schematically illustrates a patient's dentition and a shell-shaped tooth repositioner in one embodiment of the present application;

FIG. 3 schematically illustrates forces applied on the accessory by the shell-shaped tooth repositioner shown in FIG. 2;

FIG. 4 schematically illustrates an application of accessory according to one embodiment of the present application;

FIG. 5 schematically illustrates an application of accessory according to another embodiment of the present application;

FIG. 6 schematically illustrates an accessory in another embodiment of the present application;

FIG. 7 schematically illustrates an accessory in a further embodiment of the present application;

FIG. 8 schematically illustrates an accessory in a further embodiment of the present application; and

FIG. 9 schematically illustrates an accessory according to a further embodiment of the present application.

### DETAILED DESCRIPTION OF ILLUSTRATED EMBODIMENTS

In the following detailed description, reference is made to the accompanying drawings, which form a part thereof. Exemplary embodiments in the detailed description and figures are only intended for illustration purpose and not meant to be limiting. Inspired by the present application, those skilled in the art can understand that other embodiments may be utilized and other changes may be made, without departing from the spirit or scope of the present application. It will be readily understood that aspects of the present application described and illustrated herein can be arranged, replaced, combined, separated and designed in a wide variety of different configurations, all of which are explicitly contemplated and make part of the present application.

After a lot of work, the Inventors of the present application developed an accessory and an assembly of the accessory and a shell-shaped tooth repositioner, which meet all of the following requirements: (1) convenience of putting on and/or removing the shell-shaped tooth repositioner; (2) easy placement of the shell-shaped tooth repositioner in position; and (3) exertion of sufficient forces.

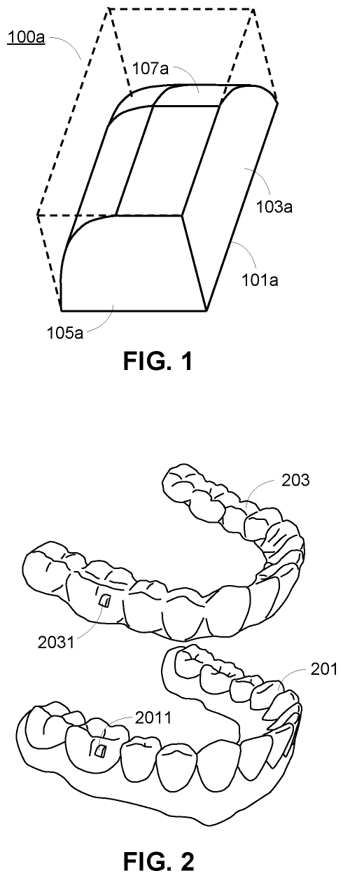

Referring to FIG. 1, it schematically illustrates an accessory 100a according to one embodiment of the present application.

The accessory 100a is a closed 3D body enclosed by a bottom surface 101a, adjoined force-applying surfaces 103a and 105a, and a guiding surface 107a.

The accessory 100a is to be fixed on a tooth via the bottom surface 101a, for example, by adhesion. Therefore, the bottom surface 101a may also be referred to as a mounting surface. In the present embodiment, the contour of the bottom surface 101a is substantially rectangular.

In one embodiment, the bottom surface 101a may be an inward-recessed cambered surface to receive more adhesive, thereby better fixing the accessory 100a on a tooth.

In one embodiment, adhesion reinforcing structures, for example, a plurality of bumps and/or dimples, may be formed on the bottom surface 101a to increase area of the bottom surface 101a in contact with adhesive, thereby better fixing the accessory 100a on a tooth.

The force-applying surfaces 103a and 105a are for a shell-shaped tooth repositioner to apply forces on, and the accessory 100a transfer these forces to a tooth on which it is mounted. The force-applying surfaces 103a and 105a are adjoined, and transition between them and a surface of tooth on which the accessory 100a is mounted (or a surface formed by extending the bottom surface 101a outwards) is relatively steep so that a shell-shaped tooth repositioner is able to apply forces on them more effectively.

In one embodiment, the force-applying surfaces 103a and 105a are planes, perpendicular to each other, and parallel to a normal direction of the bottom surface 101a.

The guiding surface 107a is for guiding an accessory receiving cavity of a shell-shaped tooth repositioner to get in position and have the accessory 100a fully received therein. In one embodiment, the accessory receiving cavity may have a geometry that matches that of the accessory 100a. Therefore, transition between the guiding surface 107a and the surface of the tooth on which the accessory 100a is mounted (or the surface formed by extending the bottom surface 101a outwards) is gentle such that it is easier to put on and remove the shell-shaped tooth repositioner. The guiding surface 107a may comprise a plurality of regions, and each region may have a different geometry. For example, a part of the guiding surface 107a opposite to the force-applying surface 105a is a cambered surface, a part of the guiding surface 107a opposite to the force-applying surface 103a is also a cambered surface, and a part of the guiding surface 107a opposite to the bottom surface 101a is a plane.

A part of the guiding surface 107a adjoins the bottom surface 101a, and the remaining part of the guiding surface 107a adjoins the two adjoining force-applying surfaces 103a and 105a.

In one embodiment, the accessory 100a may be solid. In another embodiment, the accessory 100a may be hollow.

Referring to FIG. 2, it schematically illustrates a patient's dentition 201 and a shell-shaped tooth repositioner 203 according to one embodiment of the present application.

The shell-shaped tooth repositioner is an integral shell, and forms a cavity for receiving the dentition 201. Usually, the geometry of the cavity substantially matches the dentition 201 under a target tooth arrangement of this treatment step.

An accessory 2011 is adhered to a posterior tooth of the patient's dentition 201, and a cavity 2031 for receiving the accessory 2011 is formed on the shell-shaped tooth repositioner 203 accordingly.

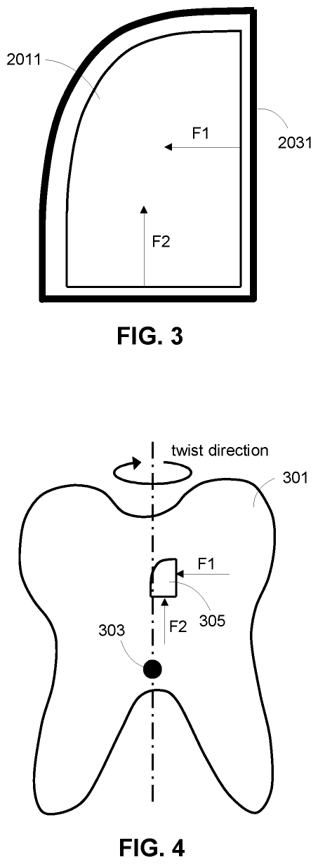

Referring to FIG. 3, it schematically illustrates forces applied on the accessory 2011 by the cavity 2031.

The geometry of the cavity 2031 substantially matches that of the accessory 2011. Since the geometry of the teeth receiving cavity of the shell-shaped tooth repositioner 203 does not match that of the dentition 201 under the current tooth arrangement, the shell-shaped tooth repositioner 203, when worn on the dentition 201, undergoes elastic deformation, and the generated elastic force drives the dentition to move to the target arrangement of the treatment step. Meanwhile, since the cavity 2031 deviates from the position of the accessory 2011 at this time, it squeezes the two force-applying surfaces of the accessory 2011 (for ease of depictions, FIG. 3 does not show the walls of the shell-shaped tooth repositioner 203 abut against the two force-applying surfaces of the accessory 2011), thereby applying two pushing forces F1 and F2 on the two force-applying surfaces, respectively.

Referring to FIG. 4, it schematically illustrates an application of an accessory according to one embodiment of the present application.

In this example, it is desired to extrude and rotate a tooth 301. In this case, an accessory 305 may be fixed on the tooth 301 at a position shown in FIG. 4, wherein the accessory 305 is located above the resistance center 303 of the tooth 301.

When worn on the dentition, the shell-shaped tooth repositioner (not shown in the figure) applies two forces F1 and F2 on the two force-applying surfaces of the accessory 305, respectively. In this example, F1 is a horizontal force, together with other forces applied by the shell-shape tooth repositioner on the tooth 301 directly or indirectly, to rotate the tooth 301 in a direction shown in FIG. 4. F2 is vertically upwards to extrude the tooth 301.

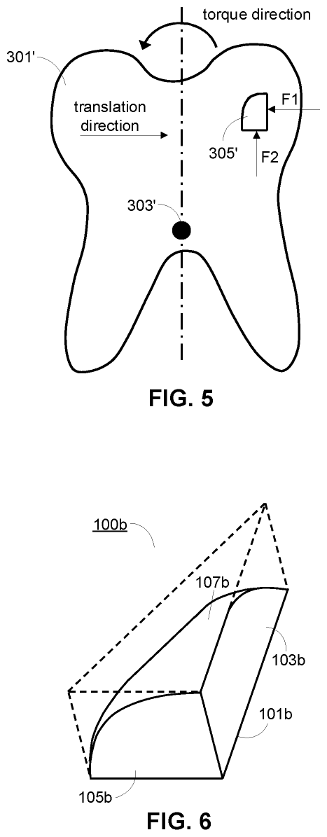

Referring to FIG. 5, it schematically illustrates another application of an accessory according to another embodiment of the present application.

In this example, under the action of a shell-shaped tooth repositioner (not shown in the figure), the tooth 301′ translates along a direction shown in FIG. 5. A resistance torque needs to be applied on the tooth 301′ along a direction shown in FIG. 5 to prevent the tooth 301′ from tipping.

In this example, the accessory 305′ may be fixed on the tooth 301′ at a position shown in FIG. 5, wherein the accessory 305′ is located above a resistance center 303′ of the tooth 301′. The shell-shaped tooth repositioner 305′ may be used to apply two forces F1 and F2 on the two force-applying surfaces of the accessory 305′, respectively. In this example, F1 is a horizontal force and F2 is a vertically upwards force. The position and direction of the accessory 305′ causes F1 and F2 to generate a torque shown in FIG. 5 to prevent the tooth 301′ from tipping.

From the above, it can be seen that since the accessory of the present application has two adjoined force-applying surfaces, forces in different directions may be simultaneously applied on the two force-applying surfaces respectively, thus by adjusting position and direction of the accessory, different demands can be met. As compared with conventional accessories with a single force-applying force, such accessory design is able to exert sufficient forces and provide more flexible applications.

In the above examples, the accessories are mounted in horizontal/vertical direction. However, inspired by the present application, it is understood that an accessory may be mounted at a certain angle according to specific demands and situations.

Referring to FIG. 6, it schematically illustrates an accessory 100b according to another embodiment of the present application.

The accessory 100b is a closed 3D body enclosed by a bottom surface 101b, adjoined force-applying surfaces 103b and 105b, and a guiding surface 107b.

In the present embodiment, the contour of the bottom surface 101b is substantially triangular.

The force-applying surfaces 103b and 105b are for a shell-shaped tooth repositioner to apply forces on, and the accessory 100b transfer these forces to a tooth on which the accessory 100b is mounted. The force-applying surfaces 103b and 105b are adjoined, and transition between them and a surface of a tooth on which the accessory 100b is mounted (or a surface formed by extending the bottom surface 101b outwards) is relatively steep so that a shell-shaped tooth repositioner is able to apply forces on them effectively.

Transition between the guidance surface 107b and the surface of the tooth on which the accessory 100b is mounted (or the surface formed by extending the bottom surface 101b outwards) is relatively gentle to make it easier to put on the shell-shaped tooth repositioner. In the present embodiment, the guiding surface 107b is a cambered surface.

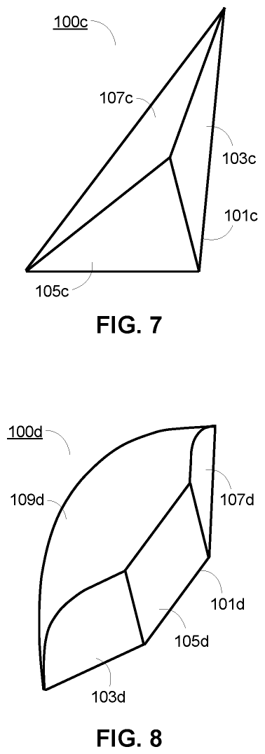

Referring to FIG. 7, it schematically illustrates an accessory 100c according to a further embodiment of the present application.

The accessory 100c is a closed 3D body enclosed by a bottom surface 101c, adjoined force-applying surfaces 103c and 105c, and a guiding surface 107c.

In the present embodiment, the contour of the bottom surface 101c is substantially triangular.

The force-applying surfaces 103c and 105c are for a shell-shaped tooth repositioner to apply forces, and the accessory 100c transfer these forces to a tooth on which the accessory 100c is mounted. The force-applying surfaces 103c and 105c are adjoined, and transition between them and a surface of the tooth on which it is mounted (or a surface formed by extending the bottom surface 101c outwards) is relatively steep so that the shell-shaped tooth repositioner is able to apply forces on them effectively.

Transition between the guiding surface 107c and the surface of the tooth on which the accessory 100c is mounted (or the surface formed by extending the bottom surface 101c outwards) is relatively gentle to make it easier to put on the shell-shaped tooth repositioner. In the present embodiment, the guidance surface 107c is a plane.

Referring to FIG. 8, it schematically illustrates an accessory 100d according to a further embodiment of the present application.

The accessory 100d is a closed 3D body enclosed by a bottom surface 101d, successively adjoined force-applying surfaces 103d, 105d and 107d, and a guiding surface 109d.

In the present embodiment, the contour of the bottom surface 101d is substantially sector-shaped.

The force-applying surfaces 103d, 105d and 107d are for a shell-shaped tooth repositioner to apply forces, and the accessory 100d transfer these forces to a tooth on which the accessory 100d is mounted. Transition between the force-applying surfaces 103d, 105d and 107d and a surface of a tooth on which the accessory 100d is mounted (or a surface formed by extending the bottom surface 101c outwards) is relatively steep so that the shell-shaped tooth repositioner is able to apply forces on them effectively.

Inspired by the present application, it is understood that the number of force-applying surfaces that are successively adjoined may be set according to specific demands, for example, 2, 3, 4, 5 or the like.

In one embodiment, among the plurality of successively adjoined force-applying surfaces, an angle between a first force-applying surface and the last force-applying surface may be greater than or equal to 60° and less than or equal to 120°. In this way, on the one hand, the shell-shaped tooth repositioner is able to apply sufficient forces on the accessory in different directions; on the other hand, as for an accessory having two parallel force-applying surfaces, while the shell-shaped tooth repositioner is put on, two side surfaces of the accessory receiving cavity of the shell-shaped tooth repositioner must perfectly align with the two parallel force-applying surfaces of the accessory, which cause the placement of the shell-shaped tooth repositioner difficult; in contrast, for the accessory of the present application, since the first force-applying surface is not parallel to the last force-applying surface, it is easier to put the shell-shaped tooth reposition in position; on the other hand, since a radiating angle between the first force-apply surface and the last force-applying surface of the accessory of the present application is large, the coverage scope of the guiding surface is large, which makes it easier to put on and remove the shell-shaped tooth repositioner.

Transition between the guiding surface 109d and a surface of a tooth on which the accessory 100d is mounted (or a surface formed by extending the bottom surface 101d outwards) is gentle to make it easier to put on a shell-shaped tooth repositioner. In the present embodiment, the guiding surface 109d is a cambered surface.

Inspired by the present application, it is understood that a guiding surface may be a single cambered surface or plane, or may be consisted of a plurality of adjoined cambered surfaces and/or planes.

Inspired by the present application, it is understood that an angle between the two adjoined force-applying surfaces may be changed according to specific demands and situations.

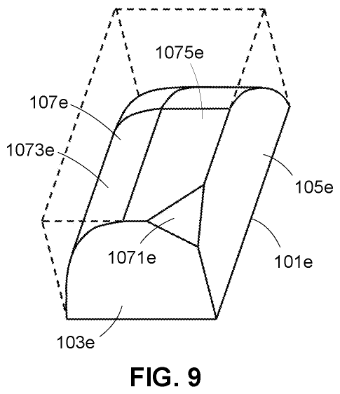

Referring to FIG. 9, it schematically illustrates an accessory 100e according to a further embodiment of the present application.

The accessory 100e is a 3D body enclosed by a bottom surface 101e, adjoined force applying surfaces 103e and 105e, and a guiding surface 107e. Each of the force applying surfaces 103e and 105e and the guiding surface 107e adjoins the bottom surface 101e. Transition between the guiding surface 107e and a surface formed by extending the bottom surface 101e outwards is gentler than transition between each of the force applying surfaces 103e and 105e and the surface formed by extending the bottom surface 101e outwards, to make it easier to put on and remove a shell shaped tooth repositioner. The guiding surface 107e includes a sub-surface 1071e, which adjoins both of the force applying surfaces 103e and 105e, and forms a slope. This slope eliminates a convex corner between the force applying surfaces 103e and 105e and the guiding surface 107e, which makes it easier to remove the shell shaped tooth repositioner.

In this embodiment, the guiding surface 107e includes three parts, a first part 1073e, a second part 1075e and the sub-surface 1071e. The first part 1073e adjoins the bottom surface 101e, and is a cambered surface. The second part 1075e adjoins the first part 1073e and the sub-surface 1071e, and is a plane. The sub-surface 1071e is also a plane. It is understood that besides plane, the sub-surface 1071e may also be a cambered surface or a curved surface.

In some embodiments, where the sub-surface 1071e meets the force applying surfaces 103e and 105e may be rounded (not shown in the figure), to make it easier to remove the shell shaped tooth repositioner.

In some embodiments, neighboring parts of a guiding surface meet may be rounded.

While various aspects and embodiments have been disclosed herein, other aspects and embodiments will be apparent to those skilled in the art, inspired by the present application. The various aspects and embodiments disclosed herein are for illustration only and are not intended to be limiting, and the scope and spirit of the present application shall be defined by the following claims.

Likewise, the various diagrams may depict exemplary architectures or other configurations of the disclosed methods and systems, which are helpful for understanding the features and functions that can be included in the disclosed methods and systems. The claimed invention is not restricted to the illustrated exemplary architectures or configurations, and desired features can be achieved using a variety of alternative architectures and configurations. Additionally, with regard to flow diagrams, functional descriptions and method claims, the order in which the blocks are presented herein shall not mandate that various embodiments of the functions shall be implemented in the same order unless otherwise the context specifies.

Unless otherwise specifically specified, terms and phrases used herein are generally intended as “open” terms instead of limiting. In some embodiments, use of phrases such as “one or more”, “at least” and “but not limited to” should not be construed to imply that the parts of the present application that do not use similar phrases intend to be limiting.

We claim:

1. An accessory for being fixed on a tooth and enabling a shell-shaped tooth repositioner to apply forces to the tooth through the accessory, wherein the accessory is a 3D body enclosed by a bottom surface, a guiding surface and N successively-adjoined force-applying surfaces, the accessory is to be fixed on the tooth by bonding the bottom surface and a surface of the tooth, both of the bottom surface and the guiding surface adjoin each of the N successively adjoined force applying surface, transition between the guidance surface and the surface of the tooth is gentler than transition between any of the N force-applying surfaces and the surface of the tooth, N is a natural number greater than or equal to 2, among the N successively-adjoined force-applying surfaces, an angle between a first force-applying surface and the N^{th} force applying surface is greater than or equal to 60° and less than or equal to 120°.

2. The accessory of claim 1, wherein the force applying surfaces are planes.

3. The accessory of claim 2, wherein the force-applying surfaces are parallel to a normal direction of the bottom surface.

4. The accessory of claim 1, wherein N equals 2.

5. The accessory of claim 4, wherein the two adjoined force-applying surfaces are planes and perpendicular to each other.

6. The accessory of claim 1, wherein a part of the guiding surface that adjoins the bottom surface is a cambered surface or a curved surface.

7. The accessory of claim 1, wherein a part of the guiding surface that adjoins the bottom surface forms a slope.

8. The accessory of claim 1, wherein a sub-surface of the guiding surface that adjoins two adjoined force applying surfaces forms a slope to avoid forming a convex corner between the guiding surface and the two adjoined force applying surfaces.

9. The accessory of claim 8, wherein where the sub-surface meets the two adjoined force applying surfaces are rounded.

10. An assembly of an accessory and a shell-shaped tooth repositioner, wherein the accessory is to be fixed on a tooth, the shell-shaped tooth repositioner is to be worn on teeth, on one of which the accessory is fixed, to re-position the teeth from a first tooth arrangement to a second tooth arrangement, the accessory is a 3D body enclosed by a bottom surface, a guiding surface and N successively-adjoined force-applying surfaces, the accessory is to be fixed on the tooth by bonding the bottom surface and a surface of the tooth, transition between the guiding surface and the surface of the tooth is gentler than transition between any of the force-applying surfaces and the surface of the tooth, the shell-shaped tooth repositioner is a one piece shell which forms a first cavity for receiving the teeth and a second cavity for receiving the accessory, when the shell-shaped tooth repositioner is worn on the teeth, walls of second cavity abut against and apply forces on at least two of the N force-applying surfaces, N is a natural number greater than or equal to 2, and among the N successively-adjoined force-applying surfaces, an angle between a first force-applying surface and the Nth force applying surface is greater than or equal to 60° and less than or equal to 120°.

11. The assembly of the accessory and the shell-shaped tooth repositioner of claim 10, wherein the force applying surfaces are planes.

12. The assembly of the accessory and the shell-shaped tooth repositioner of claim 11, wherein the force-applying surfaces are parallel to a normal direction of the bottom surface.

13. The assembly of the accessory and the shell-shaped tooth repositioner of claim 10, wherein N equals 2.

14. The assembly of the accessory and the shell-shaped tooth repositioner of claim 13, wherein the two adjoined force-applying surfaces of the accessory are planes and perpendicular to each other.

15. The assembly of the accessory and the shell-shaped tooth repositioner of claim 10, wherein a part of the guiding surface that adjoins the bottom surface is a cambered surface or a curved surface.

16. The assembly of the accessory and the shell-shaped tooth repositioner of claim 10, wherein a part of the guiding surface that adjoins the bottom surface forms a slop.

17. The assembly of the accessory and the shell-shaped tooth repositioner of claim 10, wherein a sub-surface of the guiding surface that adjoins two adjoined force applying surfaces forms a slope to avoid forming a convex corner between the guiding surface and the two adjoined force applying surfaces.

18. The assembly of the accessory and the shell-shaped tooth repositioner of claim 17, wherein where the sub-surface meets the two adjoined force applying surfaces are rounded.
